(19) United States
(12) Patent Application Publication
(10) Pub. No.: US 2020/0201610 A1
(43) Pub. Date: Jun. 25, 2020

(54) GENERATING USER INTERFACES FOR MANAGING DATA RESOURCES

(71) Applicant: Microsoft Technology Licensing, LLC, Redmond, WA (US)

(72) Inventors: Changran Wei, San Jose, CA (US); Ji Ma, Fremont, CA (US); Tianyu Fu, Santa Clara, CA (US); Hunter K. Perrin, Fremont, CA (US)

(73) Assignee: Microsoft Technology Licensing, LLC, Redmond, WA (US)

(21) Appl. No.: 16/231,078

(22) Filed: Dec. 21, 2018

(51) Int. Cl. G06F 8/38; G06F 16/21; G06F 16/22; G06F 16/2457; G06F 9/50; G06F 9/451

(52) U.S. Cl. CPC G06F 8/38; G06F 16/213; G06F 9/451; G06F 16/24573; G06F 9/5005; G06F 16/2282

(57) ABSTRACT

The disclosed embodiments provide a system that generates user interfaces for managing data resources. During operation, the system obtains a standardized schema for a data resource and an interface definition for an interface that accesses the data resource via a set of standard operations and one or more custom operations. Next, the system generates, based on the standardized schema and the interface definition, a user interface for managing the data resource using the set of standard operations and the one or more custom operations. The system then matches user input received through the user interface to an operation to be applied to a portion of the data resource. Finally, the system performs the operation by identifying the portion of the data resource in a call to the interface.

### BACKGROUND

### Field

The disclosed embodiments relate to techniques for generating user interfaces. More specifically, the disclosed embodiments relate to techniques for generating user interfaces for managing resources.

### Related Art

Data resources such as databases, data pipelines, service endpoints, data stores, and/or event streams are commonly managed using application-programming interfaces (APIs), command-line interfaces (CLIs), and/or other mechanisms provided by platforms associated with the data resources. As a result, knowledge and/or familiarity with the APIs and/or domain-specific languages (DSLs) may be required to perform basic operations such as creating, reading, updating, and/or deleting the data resources. Consequently, the use of data resources may be improved by standardizing and/or abstracting APIs, DSLs, and/or other platform-specific mechanisms for managing the data resources.

### BRIEF DESCRIPTION OF THE FIGURES

FIG. 1 shows a schematic of a system in accordance with the disclosed embodiments.

FIG. 2 shows a system for generating user interfaces for managing data resources in accordance with the disclosed embodiments.

FIG. 3 shows an example screenshot in accordance with the disclosed embodiments.

FIG. 4 shows a flowchart illustrating a process of managing a data resource in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Data resources include event streams, data pipelines, data stores, database tables, service endpoints, and/or other mechanisms for creating, collecting, sharing, transmitting, manipulating, and/or storing data. Each data resource includes records that share a common set of fields, as well as operations that can be performed on the common set of fields. For example, a data resource associated with a relational database may include a database table. Fields in the table may be defined using a schema, and a set of operations supported by the relational database may be used to interact with the fields.

To streamline interaction with the data resources, the disclosed embodiments use standardized schemas for the data resources and interface definitions for interfaces that access the data resources to generate user interfaces for managing the data resources. The standardized schemas may be created using a common data definition language (DDL) and/or adhere to a common format or structure. The interface definitions may include metadata related to standard operations (e.g., create, read, update, delete, search, access control, etc.) for interacting with the data resources and/or additional implementations of custom operations for interacting with the data resources.

The standardized schemas and/or interface definitions are then used to render the user interfaces and allow users to interact with the data resources through the user interfaces. For example, fields in a data resource may be mapped to user-interface elements according to data types of the fields from the standardized schema for the data resource. A user interface for managing the data resource may be rendered to include the user-interface elements, as well as additional user-interface elements for performing operations on the fields. User input received through the user interface may then be matched to one or more fields in the data resource and/or one or more operations to be applied to the field(s), and the operation(s) may be performed by using the interface definition to generate calls to the interface for accessing the data resource.

By generating user interfaces for managing data resources based on standardized schemas and/or interface definitions for the data resources, the disclosed embodiments may reduce overhead associated with interacting with the data resources and/or implementing the user interfaces. In contrast, conventional techniques may require users to access data resources using application-programming interfaces (APIs), command-line interfaces (CLIs), and/or platform-specific custom implementations of graphical user interfaces. Consequently, the disclosed embodiments may provide technological improvements related to the development and use of computer systems, applications, services, and/or workflows for generating user interfaces and/or managing data resources.

### Generating User Interfaces for Managing Data Resources

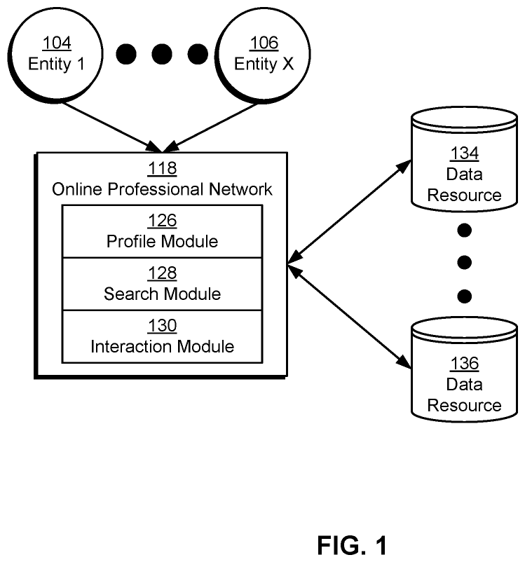

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data related to the entities' profiles and activities on online network 118 is generated, collected, transmitted, manipulated, and/or stored using a number of data resources 134-136. The data may include attributes from the members' profiles with online network 118. For example, the data may include each member's title, skills, work experience, education, seniority, industry, location, and/or profile completeness; the member's number of connections in online network 118, tenure on online network 118, and/or other metrics related to the member's overall interaction or “footprint” in online network 118; and/or attributes that are specific to one or more features of online network 118, such as a classification of the member as a job seeker or non-job-seeker.

The data may also, or instead, characterize and/or track the activity of the members with online network 118. For example, the data may include an activity level of each member, which may be binary (e.g., dormant or active) or calculated by aggregating different types of activities into an overall activity count and/or a bucketized activity score. In another example, the data may include attributes (e.g., activity frequency, dormancy, total number of user actions, average number of user actions, events, etc.) related to specific types of activity, such as messaging activity, content feed activity (e.g., publishing posts or articles, comments, like, shares, etc.), group activity (e.g., joining groups, interactions within groups, etc.), mobile activity (e.g., accessing online network 118 through a mobile device), job search activity (e.g., job searches, page views for job listings, job applications, etc.), networking activity (e.g., profile updates, profile views, connection invitations, new connections, etc.), and/or email activity (e.g., accessing online network 118 through email or email notifications).

The data may also, or instead, include attributes and/or behavior associated with companies. For example, company-related data may include demographic attributes such as a location, an industry, an age, and/or a size (e.g., small business, medium/enterprise, global/large, number of employees, etc.) of a company. In another example, company-related data may include spending related to a number of products, such as recruiting, sales, marketing, advertising, and/or educational technology solutions offered by or through online network 118. In a third example, company-related data may reflect the company's engagement with online network 118 through metrics such as a number of employees who are members of online network 118, a number of employees at a certain level of seniority (e.g., entry level, mid-level, manager level, senior level, etc.) who are members of online network 118, and/or a number of employees with certain roles (e.g., engineer, manager, sales, marketing, recruiting, executive, etc.) who are members of online 118 network. Engagement-related metrics may further include the number of online network 118 connections among employees in the company, the number of followers of the company in online network 118, and/or the number of visits to online network 118 from employees of the company.

As mentioned above, data resources 134-136 may be used to generate, collect, manipulate, transmit, store, and/or otherwise manage data in online network 118. For example, data resources 134-136 may include data and/or event streams in a distributed streaming platform such as Apache Kafka (Kafka™ is a registered trademark of the Apache Software Foundation) and/or a change data capture (CDC) pipeline that captures and propagates changes to a set of data from a source of truth for the data. In another example, data resources 134-136 may include service endpoints such as web services that adhere to Representational State Transfer (REST) constraints. In a third example, data resources 134-136 may include data stores such as relational databases, graph databases, database tables, flat files, distributed filesystems, data warehouses, and/or distributed data stores. In a fourth example, data resources 134-136 may include mechanisms for generating and/or managing data used in machine learning, data science, and/or analytics, such as feature-management systems, model-training pipelines, and/or data pipelines. In a fifth example, data resources 134-136 may include telemetry, monitoring, anomaly detection, and/or event-tracking systems.

In one or more embodiments, online network 118 includes functionality to streamline the management of data resources 134-136 by generating user interfaces for interacting with data resources 134-136. As a result, users may interact with data resources 134-136 through user-interface elements such as form fields, drop-down menus, sliders, checkboxes, radio buttons, toggles, buttons, and/or date selectors instead of learning application-programming interfaces (APIs), command-line interfaces (CLIs), and/or other resource-management mechanisms that are specific to the platforms on which data resources 134-136 are hosted.

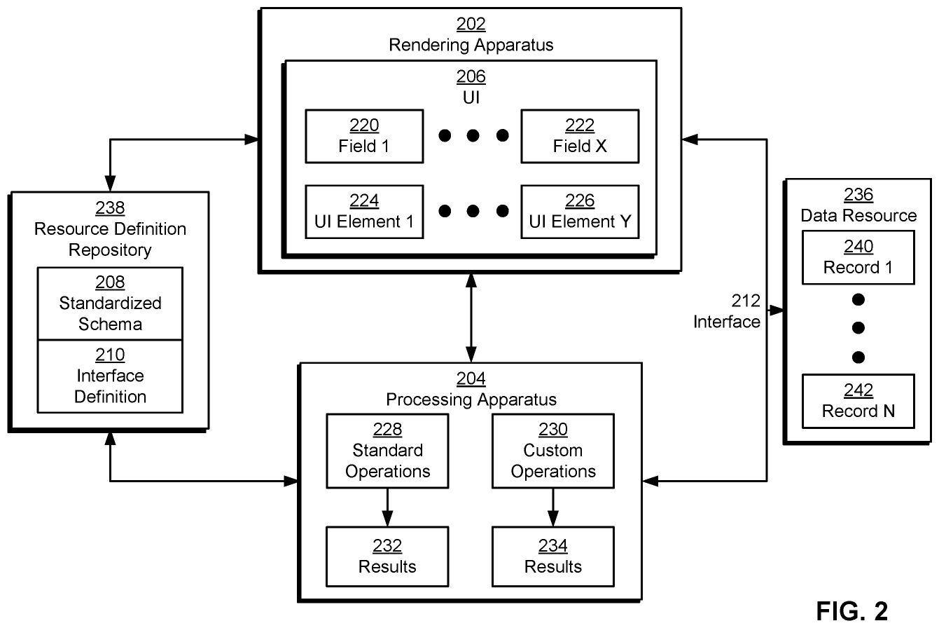

As shown in FIG. 2, a rendering apparatus 202 generates a user interface (UI) 206 containing a set of fields (e.g., field 1 220, field x 222) and a set of UI elements (e.g., UI element 1 224, UI element y 226). For example, rendering apparatus 202 may create UI 206 as a graphical user interface (GUI) within a web application, native application, mobile application, and/or other type of application, service, or component with which users can interact.

Fields displayed in UI 206 may be found in one or more records (e.g., record 1 240, record n 242) of a data resource 236. For example, rendering apparatus 202 may display names and values of the fields using text, images, audio, video, and/or other types of content within UI 206. To enable interaction with the fields, rendering apparatus 202 may also include, in UI 206, UI elements such as text boxes, drop-down menus, sliders, toggles, radio buttons, checkboxes, buttons, date pickers, tooltips, and/or icons that allow the users to specify values of the fields and/or operations to be performed on the fields.

When a user provides user input (e.g., cursor input, text input, voice input, gesture input, etc.) through UI 206, a processing apparatus 204 identifies one or more standard operations 228 and/or one or more custom operations 230 to be applied to data resource 236 based on the user input. Processing apparatus 204 performs the identified operations by making calls to an interface 212 (e.g., API) for accessing data resource 236. Processing apparatus 204 also obtains results 232-234 associated with the operations from interface 212, and rendering apparatus 202 updates user interface 206 with results 232.

In one or more embodiments, the functionality of rendering apparatus 202 and processing apparatus 204 is configured based on a standardized schema 208 for data resource 236 and an interface definition 210 for interface 212. Standardized schema 208 and interface definition 210 may be created by owners, administrators, developers, and/or other users involved in implementing and/or managing data resource 236. For example, the users may use templates, tools, text or source code editors, development frameworks, and/or other mechanisms to create standardized schema 208, interface definition 210, and an implementation of interface 212. After standardized schema 208, interface definition 210, and/or the implementation of interface 212 are created, standardized schema 208 and/or interface definition 210 may be validated by one or more tools and/or teams. Standardized schema 208 and interface definition 210 may then be stored in one or more databases, filesystems, flat files, and/or other data stores providing a resource definition repository 238. Additional standardized schemas and interface definitions for other data resources (e.g., data resources 134-136 of FIG. 1) may be created by other teams, validated, and/or stored in resource definition repository 238 to enable UI-based management of the data resources through rendering apparatus 202 and processing apparatus 204.

Standardized schema 208 defines data within data resource 236 according to a common data definition language (DDL), format, and/or structure. More specifically, standardized schema 208 includes a set of common fields that describe data resource 236. For example, the common fields may include a name, description, owner (e.g., user(s), team, platform, etc), resource key (e.g., one or more fields that uniquely identify data resource 236), deployment environment (e.g., data center fabric, data center, collocation center, cluster, etc.), and/or Uniform Resource Identifier (URI) (e.g., a path or Uniform Resource Locator (URL)) for data resource 236.

Standardized schema 208 additionally includes a set of resource-specific fields, such as fields that are stored within records of data resource 236. Each resource-specific field may be described and/or defined using a data type, which can include a primitive type such as Number, String, Enum, Byte, and/or Boolean or a collection type such as Record (e.g., a type with multiple fields), Union (e.g., any type within a unioned set of types), Array (e.g., a set of fields of the same type), and/or Map (e.g., a set of key-value pairs). The collection type may enable nesting of multiple types (e.g., an Array of Records, with each record in the array containing one or more primitive types and/or one or more other collection types). Each resource-specific field may also include a name, a description, and/or other attributes that define or describe the resource-specific field.

For example, resource-specific fields describing a data resource named “Employee” may include the following:

| Name | Type | Description |
|---|---|---|
| Email | String (email) | Unique email address that acts as a |
| | | company-wide identifier |
| First Name | String | |
| Last Name | String | |
| Date of Birth | Date | 32-bit |
| Gender | String | Enum of [Male, Female] |
| Direct Reports | Array<email> | Can be empty |

The resource-specific fields above include names of “Email,” “First Name,” “Last Name,” “Date of Birth,” “Gender,” and “Direct Reports.” The “Email,” “First Name,” “Last Name,” and “Gender” fields are of the type “String,” the “Date of Birth” field has a type of “Date,” and the “Direct Reports” field has a type of “Array<email>.” The “String” type is a primitive type, the “Array<email>” is a collection type (i.e., an array of “email” elements), and the “Date” type references a schema for another data resource named “Date.” The “Email” field has a description of “Unique email address that acts as a company-wide identifier,” the “Gender” type has a description of “Enum of [Male, Female],” and the “Direct Reports” type has a description of “Can be empty.” Thus, descriptions of the resource-specific fields may provide additional context, limitations, and/or information related to the resource-specific fields.

Interface definition 210 defines and/or describes interface 212 for accessing data resource 236. Like standardized schema 208, interface definition 210 and/or interface 212 may adhere to a standard, format, and/or set of requirements, such as requirements associated with interfaces for RESTful web services.

In one or more embodiments, interface definition 210 includes standard operations 228 and/or custom operations 230 that can be applied to fields of data resource 236 (i.e., fields defined using standardized schema 208). Standard operations 228 include create, read, update, delete, search, access control, and/or other operations that are commonly applied to data and/or used to manage access to data resources. Custom operations 230 include operations that involve business logic associated with fields of data resource 236.

For example, interface definition 210 for the “Employee” data resource described above may include the following:

| Name | Details |
|---|---|
| Annotations | Read-only fields: Email |
| Finders | findByName, findByEmail |
| Create | supported |
| Read | supported |
| Update | supported |
| Delete | supported |
| Custom | getAuthorizedActions |

The above interface definition 210 includes elements named “Annotations,” “Finders,” “Create,” “Read,” “Update,” “Delete,” and “Custom.” The “Annotations” element includes details of “Read-only fields: Email” and details of “Email address is read-only,” indicating that read-only annotations are designated for the “Email” field in the “Employee” data resource. The “Finders” element includes details of “findByName, findByEmail,” indicating that fields in the data resource can be queried by name (e.g., first and/or last name) and/or email address. The “Create,” “Read,” “Update,” and “Delete” elements have details of “supported,” indicating that the corresponding standard operations are supported by the interface. The “Custom” element includes a description of “getAuthorizedActions,” indicating that a custom operation of “getAuthorizedActions” is supported by the interface.

The example interface definition 210 above may include additional information (not shown) that can be used to execute the corresponding operations. For example, the “findByName,” “findByEmail,” and “getAuthorizedActions” methods may include additional detail that is used to execute the corresponding operations, such as a list of parameter names and types accepted by the methods and/or one or more return types for each method. In another example, interface definition 210 may include additional metadata that references standardized schema 208 (e.g., identifies the name and/or a unique identifier for standardized schema 208) and/or specifies a name or location of an implementation of interface 212 that can be called to execute the operations.

In one or more embodiments, rendering apparatus 202 displays fields and UI elements in UI 206 based on metadata for the fields in standardized schema 208 and/or operations that can be applied to the fields in interface definition 210. For example, rendering apparatus 202 may render fields in UI 206 according to mappings of String types to text fields with string input, Number types to text fields with numeric input, Date types to date pickers and/or text fields with date input, Enum types to drop-down menus, and/or Array types to lists of elements that are rendered according to the elements' data types, with an “add” button and a “delete” button for each element in the list. When standardized schema 208 includes a field containing multiple layers of nested types, rendering apparatus 202 may apply mappings of the types to corresponding UI elements recursively until all nested types are represented in corresponding UI elements.

In another example, rendering apparatus 202 may implement multiple representations of a type in UI 206 (e.g., an Enum type can be represented using a drop-down menu, a set of radio buttons, a set of buttons, and/or other UI elements), and standardized schema 208 may specify the representation to be used with a field of the type. In a third example, rendering apparatus 202 may add UI elements for performing custom operations on fields in data resource 236 based on parameters, return types, and/or other metadata for the custom operations from interface definition 210 and/or custom implementations of UI elements representing the custom operations.

When user input for accessing data resource 236 is received through UI 206, rendering apparatus 202 and/or processing apparatus 204 match the user input to one or more standard operations 228 and/or one or more custom operations 230 described in interface definition 210. Processing apparatus 204 then executes the operation(s) by generating calls to an interface represented by interface definition 210 using arguments that are passed to processing apparatus 204 by rendering apparatus 202 (e.g., arguments identifying fields in data resource 236 and/or values associated with the fields obtained from UI 206). Processing apparatus 204 also receives one or more results 232-234 of the executed operation(s) as responses to the calls and provides results 232-234 to rendering apparatus 202. Finally, rendering apparatus 202 displays results 232-234 within UI 206.

For example, rendering apparatus 202 may generate one or components within UI 206 that allow users to browse, search for, and/or otherwise retrieve records in data resource 236. When a user submits a search term through UI 206, rendering apparatus 202 may pass the search term to processing apparatus 204, and processing apparatus 204 may call one or more “Finder” methods in interface definition 210 using the search term. If the user wishes to browse records in data resource 236 (e.g., by selecting a “browse” button or UI element in UI 206), rendering apparatus 202 may pass a “browse” request and a username of the user, and processing apparatus 204 may call a “Get,” “Read,” or “Finder” method in interface definition 210 with the username as an argument. After the methods are executed, processing apparatus 204 may receive one or more sets of records as results (e.g., results 232-234) of the calls and return the results to rendering apparatus 202, and rendering apparatus 202 may display compact representations of the records in one or more lists, tables, and/or other UI elements within UI 206. The user may click on a record to access an expanded view that contains all fields of the record to which the user has access.

Rendering apparatus 202 may also, or instead, provide components within UI 206 for creating new records and/or updating existing records in data resource 236. The components may include UI elements for specifying the creation of a new record and/or editing of an existing record. When a new record is to be created, rendering apparatus 202 may display names of fields in the record from standardized schema 208, as well as UI elements (e.g., text fields, sliders, drop-down menus, checkboxes, radio buttons, date pickers, buttons, dials, etc.) for specifying or selecting values of the fields. When an existing record from the same data resource (e.g., data resource 236) is to be updated, rendering apparatus 202 may display the same field names and UI elements and populate the UI elements with current values of the corresponding fields. Rendering apparatus 202 may also display UI elements for saving and/or submitting the new record and/or updates to the existing record. When the user saves and/or submits fields the new record and/or updates to the existing record, rendering apparatus 202 may transmit the fields to processing apparatus 204, and processing apparatus 204 may call a “Create” or “Update” method described in interface definition 210 with the fields. After execution of the method is complete, processing apparatus 204 may transmit confirmation of the corresponding operation to rendering apparatus 202, and rendering apparatus 202 may display the confirmation and/or corresponding field values within UI 206.

Rendering apparatus 202 may also, or instead, provide components within UI 206 for deleting existing records in data resource 236. When an existing record is to be deleted (e.g., after the user selects a “delete” button next to the record in UI 206), rendering apparatus 202 may prompt the user for confirmation of the deletion. When the confirmation is received, rendering apparatus 202 may transmit a request for the deletion and an identifier of the record to processing apparatus 204, and processing apparatus 204 may call a “Delete” method described in interface definition 210 with the identifier of the record as an argument. After the deletion is complete, processing apparatus 204 may transmit confirmation of the deletion to rendering apparatus 202, and rendering apparatus 202 may display the confirmation within UI 206.

Rendering apparatus 202 may also, or instead, provide components within UI 206 for applying custom operations 230 to records in data resource 236. Rendering apparatus 202 may use information in standardized schema 208, interface definition 210, and/or implementations of UI elements representing custom operations 230 to display the UI elements in UI 206, and the user may interact with the UI to invoke custom operations 230. In turn, rendering apparatus 202 may communicate the invocations and relevant data (e.g., fields, field values, options, etc.) to processing apparatus 204, and processing apparatus 204 may call the corresponding methods for performing custom operations 230 in interface definition 210. Processing apparatus 204 may subsequently receive results 234 of executed custom operations 230, and rendering apparatus 202 may display representations of results 234 in UI 206.

By generating UIs for managing data resources based on standardized schemas and/or interface definitions for the data resources, the disclosed embodiments may reduce overhead associated with interacting with the data resources and/or implementing the UIs. In contrast, conventional techniques may require users to access data resources using application-programming interfaces (APIs), command-line interfaces (CLIs), and/or platform-specific custom implementations of GUIs. Consequently, the disclosed embodiments may provide technological improvements related to the development and use of computer systems, applications, services, and/or workflows for generating UIs and/or managing data resources.

Those skilled in the art will appreciate that the system of FIG. 2 may be implemented in a variety of ways. In particular, rendering apparatus 202, processing apparatus 204, resource definition repository 238, and/or data resource 236 may be provided by a single physical machine, multiple computer systems, one or more virtual machines, a grid, one or more databases, one or more filesystems, and/or a cloud computing system. Rendering apparatus 202 and processing apparatus 204 may additionally be implemented together and/or separately by one or more hardware and/or software components and/or layers.

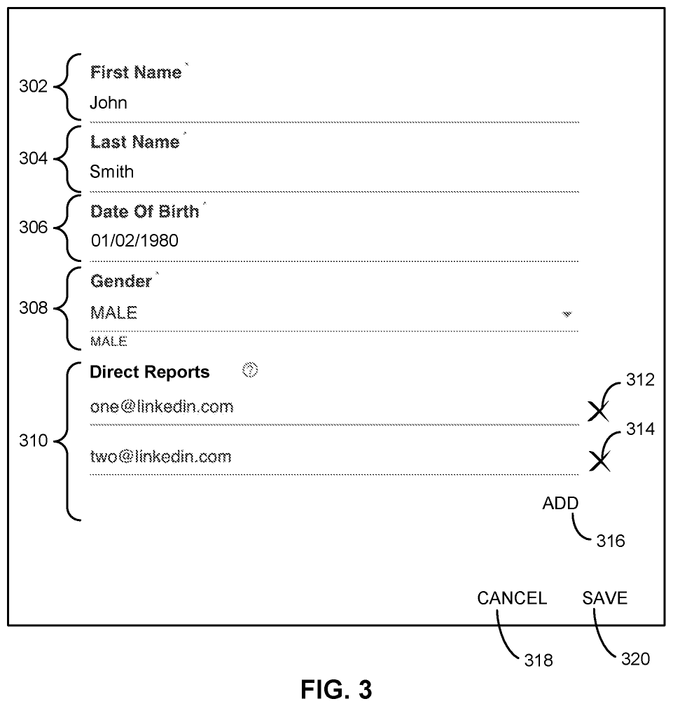

FIG. 3 shows an example screenshot in accordance with the disclosed embodiments. More specifically, FIG. 3 shows a screenshot of a UI for managing a data resource, such as UI 206 of FIG. 2.

The UI of FIG. 3 includes a number of portions 302-310 related to fields in the example “Employee” data resource described above. For example, portions 302-310 may be used to create a new “Employee” record and/or modify an existing “Employee” record in the data resource. As a result, portions 302-310 may be displayed to a user after the user selects a UI element for creating a new “Employee” record. Portions 302-310 may also, or instead, be shown after the user selects a UI element for updating an existing “Employee” record after the record is displayed in a set of search results and/or a list of records to which the user has modification rights.

Portion 302 includes a field name of “First Name” and a text field containing a value of “John” for the corresponding field, and portion 304 includes a field name of “Last Name” and a text field containing a value of “Smith” for the corresponding field. A user may modify the field values in portions 302-304 by updating the contents of the corresponding text fields.

Portion 306 includes a field name of “Date Of Birth” and a field containing a value of “01/02/1980” for the corresponding field. The user may modify the field value in portion 306 by interacting with a date picker (not shown) that is displayed when the field is selected and/or by modifying the text in “MM/DD/YYYY” format within the field.

Portion 308 includes a field name of “Gender” and a drop-down menu containing a selected value of “MALE” for the corresponding field. The user may modify the field value in portion 308 by selecting a different option (e.g., “FEMALE,” “UNKNOWN,” etc.) within the drop-down menu.

Portion 310 includes a field name of “Direct Reports” and two text fields with values of “one@linkedin.com” and “two@linkedin.com.” Each text field represents an element of the Array type associated with the “Direct Reports” field in the standardized schema for “Employee” described above. The user may modify values in each text field to update the value of the corresponding array element. The user may also select UI elements 312-314 next to the text fields to delete the corresponding array elements. Portion 310 additionally includes a UI element 316 that can be selected to add additional elements to the array. When UI element 316 is selected, a new text field is generated within portion 310, and the user may input a value of the corresponding element into the text field.

Portions 302-310 may be rendered within the UI according to types for the corresponding fields specified in a standardized schema for the data resource. For example, portions 302-304 may include text fields to reflect String types for the “First Name” and “Last Name” fields, portion 306 may include a text field and/or date picker to reflect a custom Date type for the “Date Of Birth” field, portion 308 may include a drop-down menu to reflect an Enum type for the “Gender” field, and portion 310 may include a variable number of text fields and additional UI elements 312-316 for adding and removing text fields to reflect the Array<email> type for the “Direct Reports” field.

After the user has finished creating or updating the record, the user may select a UI element 320 to save field values shown in portions 302-310 within the record. In turn, a method for creating or updating the record may be invoked with the field values as arguments. Alternatively, the user may select a different UI element 318 to cancel creating or updating the record using the field values shown in the UI.

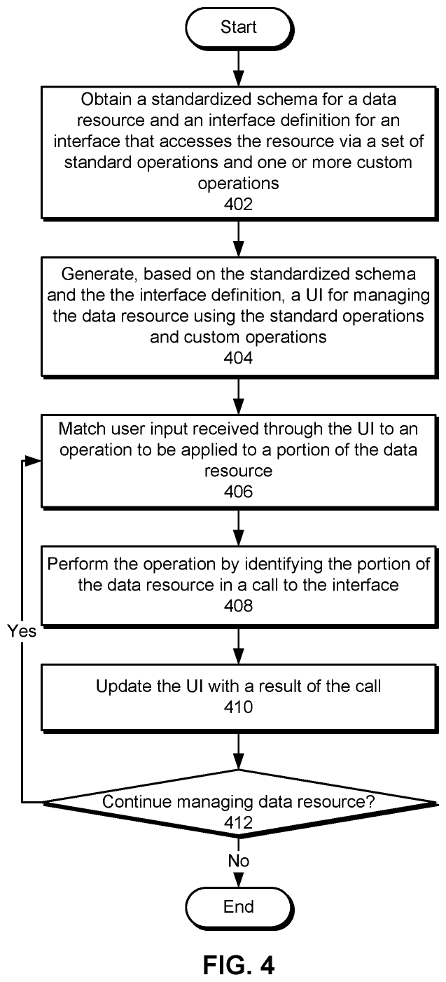

FIG. 4 shows a flowchart illustrating a process of managing a data resource in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a standardized schema for a data resource and an interface definition for accessing the data resource via a set of standard operations and one or more custom operations are obtained (operation 402). The standardized schema may include a set of common fields that describe the data resource, such as a name, description, owner, resource key, deployment environment, and/or URI for the data resource. The standardized schema may also include a set of resource-specific fields that describe and/or define data that is found within the data resource. The resource-specific fields may include a name of each field in the data resource, a type of the field (e.g., primitive types, collection types, and/or references to types that are defined in other standardized schemas), and/or a description of the field. The interface definition may identify support for standard operations such as create, read, update, delete, search, and/or access control, as well as metadata for custom operations (e.g., names, descriptions, parameter names, parameter types, return types, etc.) that support business logic related to the data resource.

Next, a UI for managing the data resource using the standard operations and custom operations is generated based on the standardized schema and the interface definition (operation 404). For example, fields in the data resource may be shown within UI elements in a GUI based on the data types of the fields and mappings from the fields and/or data types from the standardized schema to the UI elements. Additional UI elements for applying various standard and/or custom operations described in the interface definition to the data resource may also be displayed in the UI. In another example, a UI element representing a field in the data resource may be defined, selected, and/or specified in the standardized schema, interface definition, and/or other metadata used to generate the UI.

User input received through the UI is then matched to an operation to be applied to a portion of the data resource (operation 406). For example, the user input may include values specified through one or more UI elements and/or selection of one or more UI elements. The values and/or UI elements may be mapped to corresponding fields in the standardized schema and/or operations in the interface definition.

The operation is performed by identifying the portion of the data resource in a call to the interface (operation 408). For example, a call to a function or method for performing the operation may be made, and values, fields, and/or options associated with the portion of the data resource may be passed as arguments to the function or method.

Finally, the UI is updated with a result of the call (operation 410). For example, the UI may be updated to show a search result; a set of newly read, created, and/or updated fields in the data resource; and/or confirmation of a deletion operation.

Operations 406-410 may be repeated while the data resource is being managed (operation 412) through the UI. For example, the UI may be used to receive user input, carry out operations related to the user input, and updated to reflect results of the executed operations while a user interacts with the UI to manage the data resource. As a result, the UI may reduce overhead associated with managing data resources using APIs, CLIs, query languages, and/or other mechanisms that require domain-specific knowledge associated with the data resources.

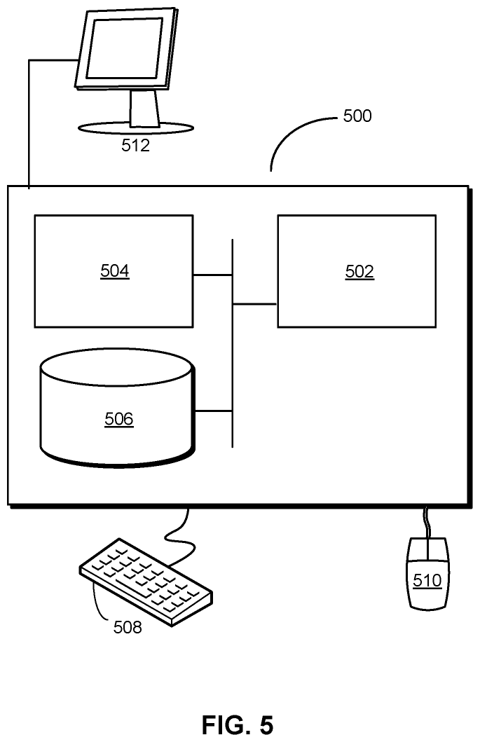

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for generating UIs for managing resources. The system includes a rendering apparatus and a processing apparatus, one or more of which may alternatively be termed or implemented as a module, mechanism, or other type of system component. The rendering apparatus and processing apparatus obtain a standardized schema for a data resource and an interface definition for an interface that accesses the data resource via a set of standard operations and one or more custom operations. Next, the rendering apparatus generates, based on the standardized schema and the interface definition, a UI for managing the data resource using the set of standard operations and the one or more custom operations. The rendering apparatus and processing apparatus then match user input received through the UI to an operation to be applied to a portion of the data resource. Finally, the processing apparatus performs the operation by identifying the portion of the data resource in a call to the interface.

In addition, one or more components of computer system 500 may be remotely located and connected to the other components over a network. Portions of the present embodiments (e.g., rendering apparatus, processing apparatus, data resource, resource definition repository, online network, UI, etc.) may also be located on different nodes of a distributed system that implements the embodiments. For example, the present embodiments may be implemented using a cloud computing system that generates UIs for managing a set of remote data resources.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a standardized schema for a data resource and an interface definition for an interface that accesses the data resource via a set of standard operations and one or more custom operations;
generating, based on the standardized schema and the interface definition, a user interface for managing the data resource using the set of standard operations and the one or more custom operations;
matching, by one or more computer systems, user input received through the user interface to an operation to be applied to a portion of the data resource; and
performing, by the one or more computer systems, the operation by identifying the portion of the data resource in a call to the interface.

2. The method of claim 1, further comprising:
updating the user interface with a result of the call.

3. The method of claim 2, wherein the result comprises at least one of:
a search result;
a set of fields in the data resource; and
confirmation of the performed operation.

4. The method of claim 1, wherein the standardized schema comprises:
a set of common fields; and
a set of resource-specific fields for the data resource.

5. The method of claim 4, wherein the set of common fields comprises at least one of:
a name;
a description;
a resource key; and
a Uniform Resource Identifier (URI).

6. The method of claim 1, wherein the interface definition comprises:
an annotation;
support for one or more of the standard operations; and
metadata related to the one or more custom operations.

7. The method of claim 1, wherein generating the user interface for managing the data resource using the set of standard operations and the one or more custom operations comprises:
displaying, based on the standardized schema, representations of a set of fields in the data resource; and
generating, within the user interface, user-interface elements for applying the set of standard operations and the one or more custom operations to the set of fields.

8. The method of claim 7, wherein the set of fields comprises at least one of:
a primitive type;
a collection type; and
a reference to another standardized schema.

9. The method of claim 1, wherein the set of standard operations comprises:
a create operation;
a read operation;
an update operation; and
a delete operation.

10. The method of claim 1, wherein the set of standard operations comprises at least one of:
a search operation; and
an access control operation.

11. The method of claim 1, wherein the data resource is at least one of:
a database;
a table;
a data store;
an event stream;
a service endpoint; and
a data pipeline.

12. A system, comprising:
one or more processors; and
memory storing instructions that, when executed by the one or more processors, cause the system to:
obtain a standardized schema for a data resource and an interface definition for an interface that accesses the data resource via a set of standard operations and one or more custom operations;
generate, based on the standardized schema and the interface definition, a user interface for managing the data resource using the set of standard operations and the one or more custom operations;
match user input received through the user interface to an operation to be applied to a portion of the data resource; and
perform the operation by identifying the portion of the data resource in a call to the interface.

13. The system of claim 12, wherein the memory further stores instructions that, when executed by the one or more processors, cause the system to:
update the user interface with a result of the call.

14. The system of claim 12, wherein the standardized schema comprises:
a set of common fields; and
a set of resource-specific fields for the data resource.

15. The system of claim 14, wherein the set of common fields comprises at least one of:
a name;
a description;
a resource key; and
a Uniform Resource Identifier (URI).

16. The system of claim 14, wherein the set of resource-specific fields comprises at least one of:
a name;
a type; and
a description.

17. The system of claim 12, wherein the interface definition comprises:
an annotation;
support for one or more of the standard operations; and
metadata related to the one or more custom operations.

18. The system of claim 17, wherein the metadata related to the one or more custom operations comprises at least one of:
a name;
a parameter; and
a return type.

19. The system of claim 12, wherein the set of standard operations comprises at least one of:
a create operation;
a read operation;
an update operation;
a delete operation;
a search operation; and
an access control operation.

20. A non-transitory computer-readable storage medium storing instructions that when executed by a computer cause the computer to perform a method, the method comprising:
obtaining a standardized schema for a data resource and an interface definition for an interface that accesses the data resource via a set of standard operations and one or more custom operations;
generating, based on the standardized schema and the interface definition, a user interface for managing the data resource using the set of standard operations and the one or more custom operations;
matching user input received through the user interface to an operation to be applied to a portion of the data resource;
performing the operation by identifying the portion of the data resource in a call to the interface; and
updating the user interface with a result of the call.
